(19) United States
(12) Patent Application Publication
(10) Pub. No.: US 2004/0268385 A1
(43) Pub. Date: Dec. 30, 2004

(54) User originated content notification

(76) Inventors: James Harold Gray, Ellijay, GA (US); Thomas Jefferson Brothers, Gainesville, GA (US); William Randolph Matz, Atlanta, GA (US)

Correspondence Address: BAMBI FAIVRE WALTERS, PO BOX 5743, WILLIAMSBURG, VA, 23188, US

(21) Appl. No.: 10/610,776

(22) Filed: Jun. 30, 2003

(51) Int. Cl. H04N 7/025; H04N 7/10; H04N 7/173; H04N 7/16

(52) U.S. Cl. 725/34; 725/139; 725/110

(57) ABSTRACT

According to one aspect of the present invention, a method of originating a hot key signal from a terminal device of a user of an interactive television service, the method comprises determining a destination for the hot key signal and determining a location of the available content. The hot key signal including the destination for the hot key signal and the location of the available content is then generated and transmitted from the user's terminal device over a network connected with the user's terminal device.

### RELATED APPLICATIONS

This application is related to co-pending application number ______ filed on Jun. 30, 2003.

### FIELD OF THE INVENTION

The various embodiments of the invention disclosed herein relate generally to the field of interactive television. More particularly, these embodiments relate to providing user originated content notification.

### BACKGROUND OF THE INVENTION

Advances in telecommunications and computing technology have led to the use of interactive television (TV) services on a large scale. Where such services are available, users are not only able to access television content by passively receiving it, but are also beginning to interact with the service providers by communicating requests and/or commands to the service providers. These requests and/or commands may be communicated to the service provider via the same path over which the programming services are provided or even via other paths.

Interactive television may be provided over any number of paths, including coaxial cable or optical fiber, hybrid fiber/coaxial, or any other suitable path that accommodates sufficient bandwidth for desired video channels as well as other telecommunications services. Content providers may include, for example, providers of over-the-air programming such as commercial television stations, cable programming such as weather, travel and entertainment channels, game channels, and other interactive services of various types.

Generally, TV service provides a user or users with a variety of options such as: traditional broadcast and cable television programming; video services, such as pay-per-view (PPV), near video-on-demand (NVOD), video-on-demand (VOD), promo channels, electronic program guides, etc.; cable delivered PC-based services; and interactive services through the use of a combination of compression and digital video technologies. TV services may also provide menuing capabilities and upstream signaling from users to service providers.

The combination of broadcast and interactive applications over interactive TV (e.g., interactive content) creates a possible mode of communication in which a user, if informed of the availability of alternate interactive content relating to a subject matter of interest, may invoke the alternate content to investigate that subject matter more thoroughly and according to his or her own tastes. However, television viewers, who are accustomed to choosing at will between the available transmitted channels with instantaneous results, will expect to be informed of the alternate content in a convenient and timely manner and to pass from one medium to another seamlessly.

### SUMMARY OF THE INVENTION

A method and apparatus are described that provide user originated content notification. According to one aspect of the present invention, a method of originating a hot key signal from a terminal device of a user of an interactive television service comprises determining a destination for the hot key signal and determining a location of the available content. The hot key signal including the destination for the hot key signal and the location of the available content is then generated and transmitted from the user's terminal device over a network connected with the user's terminal device. Other features of the present invention will be apparent from the accompanying drawings and from the detailed description that follows.

### BRIEF DESCRIPTION OF THE DRAWINGS

The appended claims set forth the features of embodiments of the invention with particularity. The invention, together with its advantages, may be best understood from the following detailed description taken in conjunction with the accompanying drawings of which:

FIGS. 1A-1D illustrate a television displaying a picture containing a hot key for informing a user of available alternate content and redirecting the user to the alternate content responsive to selection of the embedded hot key according to one embodiment of the present invention;

FIG. 2 is a block diagram illustrating a network over which user originate content notification signals may be transmitted and received according to one embodiment of the present invention;

FIG. 3 is a block diagram illustrating one possible format for a user originated content notification signal according to one embodiment of the present invention;

FIG. 4 is a block diagram of a user side system to send and receive user originated content notification and redirect a user to alternate content responsive to selection of an embedded hot key according to one embodiment of the present invention;

FIG. 5 is and flowchart illustrating processing on a user side system for generating and sending user originated content notification signals according to one embodiment of the present invention; and

FIG. 6 is a flowchart illustrating processing on a user side system for receiving and redirecting a user to alternate content responsive to selection of an embedded hot key according to one embodiment of the present invention.

### DETAILED DESCRIPTION OF THE INVENTION

In the following description, for the purposes of explanation, numerous specific details are set forth in order to provide a thorough understanding. It will be apparent, however, to one skilled in the art that embodiments of the present invention may be practiced without some of these specific details. In other instances, well-known structures and devices are shown in block diagram form.

Embodiments of the present invention include various processes, which will be described below. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, Compact Disk Read-Only Memories (CD-ROMs), and magneto-optical disks, Read-Only Memories (ROMs), Random Access Memories (RAMs), Erasable Programmable Read-Only Memories (EPROMs), Electronically Erasable Programmable Read-Only Memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

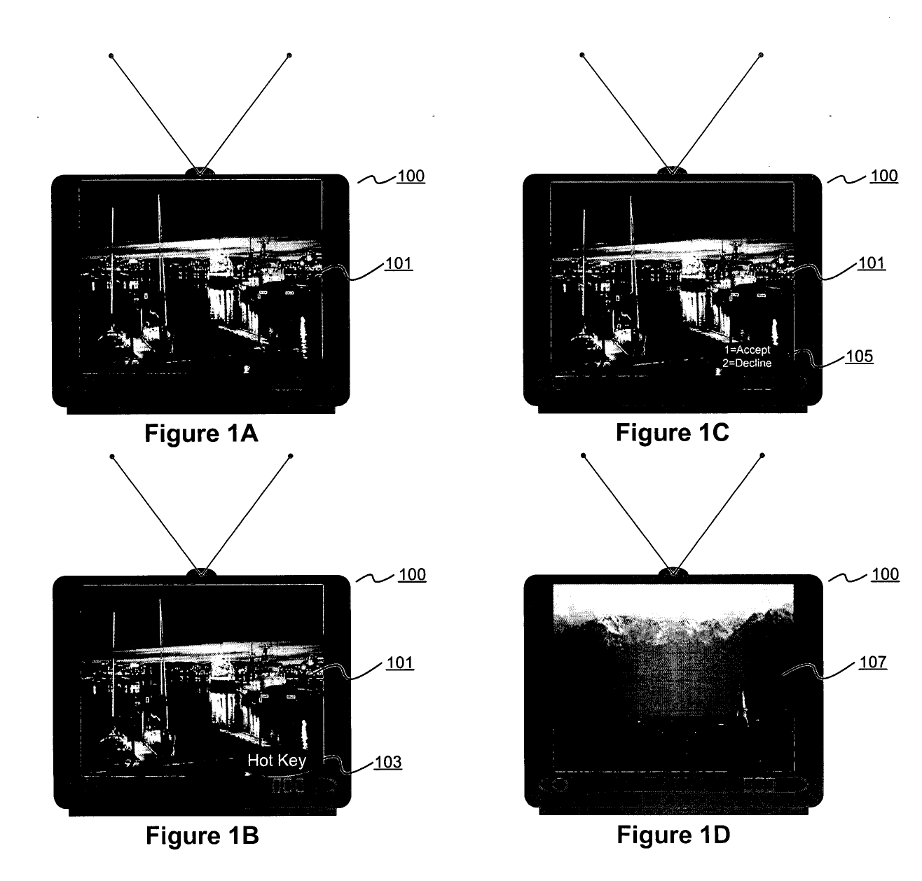

FIGS. 1A-1D illustrate a television displaying a picture containing a hot key for informing a user of available alternate content and redirecting the user to the alternate content responsive to selection of the embedded hot key according to one embodiment of the present invention. These figures represent respectively a process of viewing content, receiving a hot key, accepting a hot key, and redirecting to alternate content.

Specifically, FIG. 1A illustrates an example of viewing content. Here, a video program 101 is being displayed on television 100. Alternatively, a user may be viewing other types of interactive TV content such as pay-per-view video content, interactive games, etc.

FIG. 1B illustrates an example of receiving a hot key. In this example, the user is tuned to the same video program 101 on television 100 is in the previous example of FIG. 1A. However, in this example an icon 103 or other graphic has been displayed to indicate to the user that a hot key has been received. The hot key indicates that alternate content is available for the user's consumption. According to one embodiment of the present invention, the alternate content may be in the form of another video program with content related to the video program 101 being viewed by the user.

FIG. 1C illustrates an example of accepting a hot key. In this example, the user is tuned to the same video program 101 as in FIGS. 1A and 1B. Icon 105, displayed to indicate to the user that a hot key has been received, now indicates a manner in which the user may accept or decline the alternate content. In this example, icon 105 indicates that the user may press 1 to accept the alternate content or 2 to decline the alternate content.

Of course, other methods of accepting or declining the alternate content may be used. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Pressing the hot key button may be a manner in which the user accepts the alternate content and is redirected to that content without further interaction from the user. According to another embodiment, the user may decline the alternate content by taking no action at all. That is, after some time period during which no action is taken by the user to accept the alternate content, the hot key may simply time out and expire. Various other methods of accepting or declining the alternate content may also be used.

Regardless of the exact operation used to accept the alternate content, FIG. 1D illustrates redirecting a user to alternate content responsive to the hot key being accepted. According to one embodiment of the present invention, the hot key signal may be a user-originated signal from another user on the service provider's network and the alternate content may be another video program indicated by the other user. Therefore, television 100 in FIG. 1D illustrates an alternate video program 107 being displayed.

According to one embodiment of the present invention, two users on the service provider's network may be viewing content independently. The content being viewed by the two users may or may not be related. The first user may find the content he is viewing of interest to the second user with whom he is acquainted. For example, the first user may be viewing a very exciting football game. This user knows that his friend, the second user, is also an avid football fan and would enjoy watching the remainder of this game. The first user may then wish to send a signal to the second user to alert him of this particular content. The second user, upon receiving this signal, may then choose to accept or decline the alternate content as discussed above.

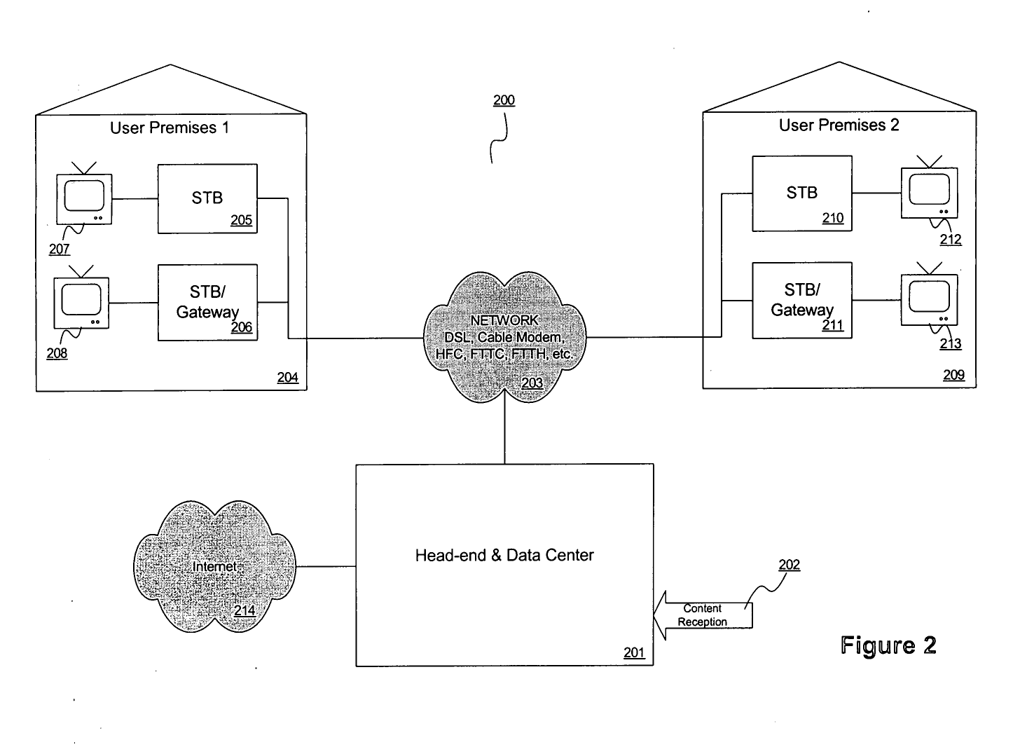

As will be described below with reference to FIG. 2, a system over which interactive television signals containing user originated hot key signals may be transmitted according to various embodiments of the present invention may occur over different types of networks. These different types of networks include, but are not limited to, cable, satellite, Fiber-to-the-Curb (FTTC), Fiber-to-the-House (FTTH), Very high speed Digital Subscriber Line (VDSL), and others.

FIG. 2 is a block diagram illustrating a network over which user originate content notification signals may be transmitted and received according to one embodiment of the present invention. This example illustrates, at a high-level, an architecture of a service provider's system 200 that includes head-end and data center 201, network 203, user premises 1 204, and user premises 2 209. Each user premises 204 and 209 contains one or more Set-Top Boxes (STBs) 205 and 210 and/or STB/gateways 206 and 211 as well as one or more televisions 207, 208, 210 and 211 or other content viewing devices. The STBs 205 and 210 and/or STB/gateways 206 and 211 at the user premises 204 and 209 may be connected with head-end and data center 201 via network 211. Finally, head-end and data center 201 may be connected with the Internet 214.

An interactive TV service provider typically operates and maintains a head-end and data center 201 equipped to receive signals 202 from one or more content providers. Content providers may be any original or secondary source of programming or information generally including, for example, interactive or non-interactive over-the-air programming such as commercial television stations, cable programming such as weather, travel and entertainment channels, game channels, and other interactive services of various types. Head-end and data center 201, after receiving content from one or more content providers, may then transmit the interactive content to users premises 204 and 209. Typically, the transmission from head-end and data center comprises a carrier frequency modulated with compressed video signals of multiple channels multiplexed together.

Optionally, head-end and data center 201 may be connected with the Internet 214 via a high-speed connection 215 such as a fiber optic connection. If connected to the Internet 214 the service provider, through head-end and data center 210 may provide users with content from Internet sites and/or provide other services such as email, instant messaging, etc.

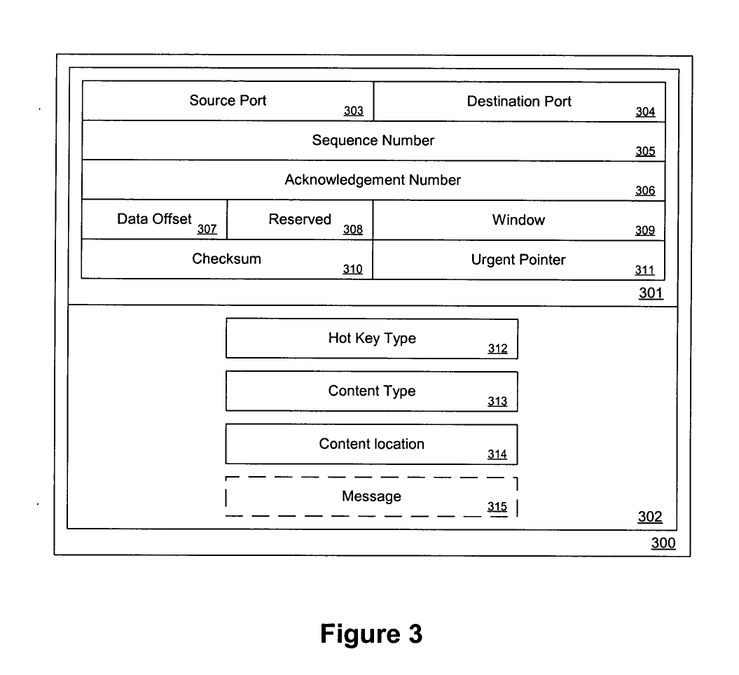

Head-end and data center 201 may transmit content to user premises 204 and 209 via network 203. Network 203 may be any of a variety of different types implemented over a variety of different media. For example, network 203 may comprise a Digital Subscriber Line (DSL) network, cable modem network, Hybrid Fiber Coax (HFC) network, Fiber-To-The-Curb (FTTC) network, Fiber-To-The-House (FTTH) network, etc. Network 203 may also transmit content using a variety of formats and protocols. For example, the content may be transmitted as an MPEG-2 data stream using a network protocol such as IP. Therefore the content may be transmitted from head-end and data center 201 as IP data packets or in another similar format. One possible example of such a packet will be discussed below with reference to FIG. 3.

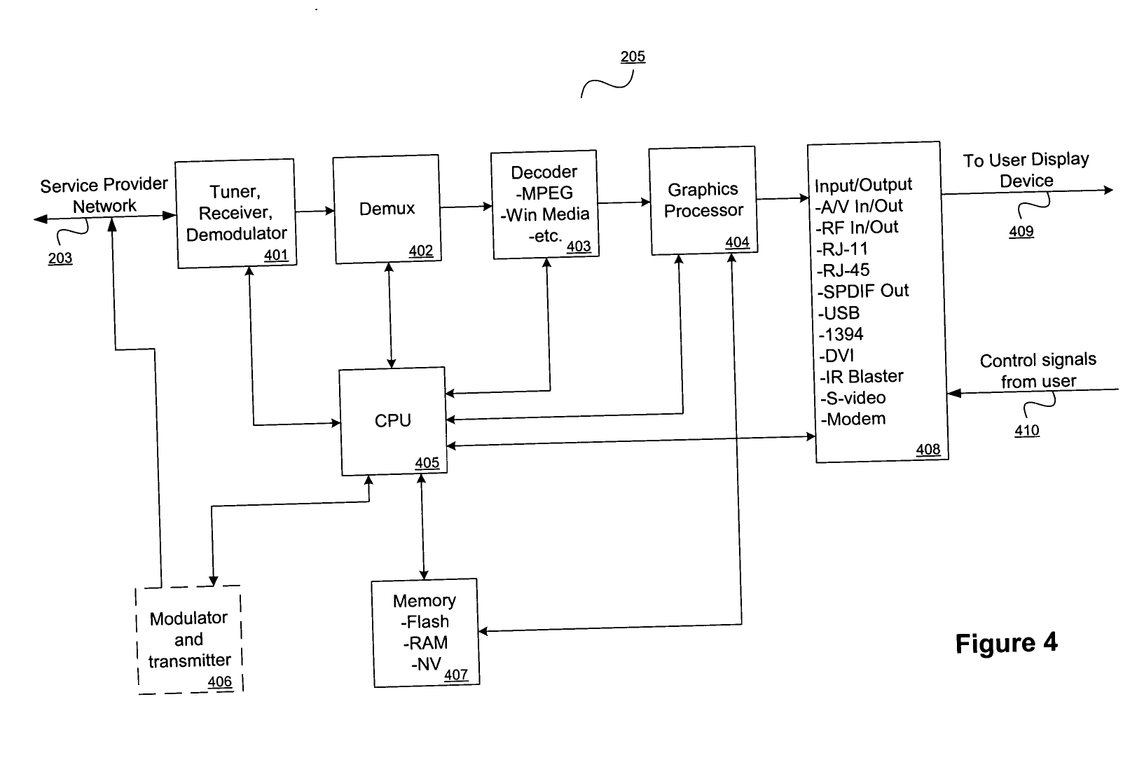

Regardless of the format of the transmission, a signal carrying the interactive TV content is received at user premises 204 and 209 via network 203. Connected with network 203 at user premises 204 and 209 may be some form of terminal device. In the example illustrated by FIG. 2, two possible types of terminal devices, STB/Gateway 206 and 211 and STB 205 and 210 are shown. The terminal device, STB, Gateway, or other device, performs functions such as exchanging messages (including video-related data) over network 203 with head-end and data center 201, receiving messages from a user input device, such as a hand-held remote control unit or keyboard, translating video signals from a network-native format into a format that can be used by televisions 207, 208, 210, and 211 or other display devices, and providing a video signal to televisions 207, 208, 210, and 211 or other display devices. STB/Gateways 206 and 211 and STBs 205 and 210 may also be capable of performing other functions, such as inserting alphanumeric or graphical information into the video stream in order to “overlay” that information on the video image, providing graphic or audio feedback to a user, or routing a traditional broadcast signal to a viewing device to which another STB is connected. Additional details of the hardware of STBs 205 and 210 and the processing performed therein will be discussed below with reference to FIGS. 4 through 6.

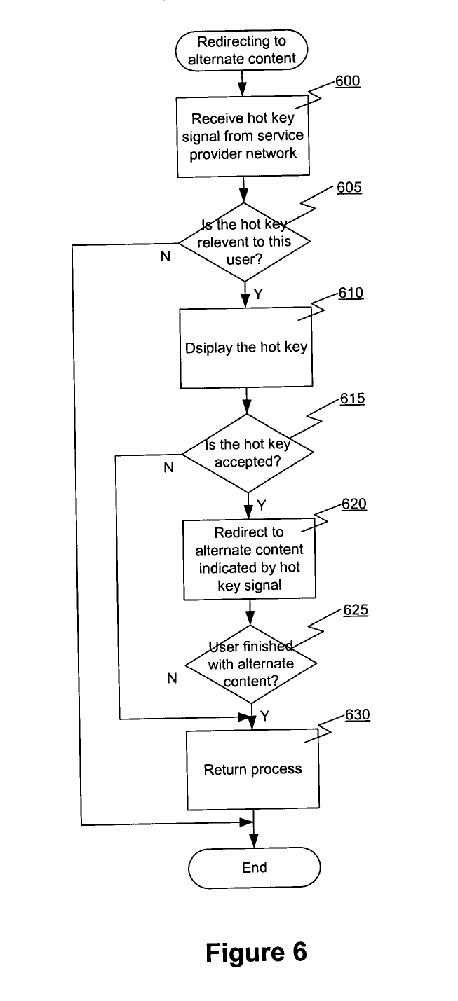

In use, STB/Gateway 206 or STB 205 at user premises 1 204 may receive hot key signals originated at STB/Gateway 211 or STB 210 at user premises 2 209 or vise versa. STB/Gateway 206 or STB 205 may then notify the user of available alternate content as discussed above with reference to FIG. 1. STB/Gateway 206 or STB 205 may then receive some form of user feedback indicating that the user accepts or declines the alternate content. If the user accepts the alternate content, STB/Gateway 206 or STB 205 may then redirect the user to this alternate content as will be discussed further below with reference to FIGS. 4 and 6.

According to one embodiment of the present invention, two users, one at user premises 1 204 and one at user premises 2 209, and connected to the service provider's network 203 may be viewing content independently. The content being viewed by the two users may or may not be related. The first user at user premises 1 204 may find the content he is viewing of interest to the second user at user premises 2 209. For example, the first user may be viewing a home improvement program describing a remodeling project. This user knows that his friend, the second user, is planning a similar remodeling project. The first user may then wish to send a signal to the second user to alert him of this particular program. The second user, upon receiving this signal, may then choose to accept or decline the alternate content as discussed above.

FIG. 3 is a block diagram illustrating one possible format for a user originated content notification signal according to one embodiment of the present invention. This example illustrates an IP data packet 300. Alternatively, the hot key signal may be any other type of digital signal or packet suitable for transmission over the type of network being used and capable of carrying information similar to that shown here. The IP data packet includes a header 301 and a body 302.

Header 301 includes a number of fields 303-311 that are typically found in IP data packets. These fields include a source port 303, a destination port 304, a sequence number 305, an acknowledgement number 306, a data offset 307, a reserved field 308, a window field 309, checksum data 310, and an urgent pointer 311. Once again, these fields are typically found in IP data packets and their data and purpose are well-known in the art.

Body 302 may also include a number of fields 312-315. These fields may include a hot key type 312, a content type 313, a content location 314, and optionally a message field 315. In various applications, the number of fields used, size of the fields, type of data presented, format of the data, content of the fields, etc. may vary. For example, in some cases not all of the fields presented here may be used. In other cases, additional data may be presented such as additional graphical or textual information. Additionally, the data may be presented in a wide variety of formats such as plain American Standard Code for Information Interchange (ASCII) text, other binary representations or even encrypted.

Regardless of format, hot key type field 312 may represent the type of hot key signal being used. For example, the hot key signal represented by IP data packet 300 may indicate that alternate content is available on another channel or on a web site. Alternatively, the hot key signal may indicate that alternate content is available to be cached on the user's terminal device.

Content type field 313 may represent the type, genre, or other details about the alternate content. For example, this field 313 may be used to indicate that the alternate content is a sporting event or movie. Of course, additional details may also be included. For example, the field 313 may indicate that the alternate content is an action movie and name the actors and director. This information may be used by the user's terminal device to judge the relevance of the hot key signal to the user as will be discussed below.

Content location field 314 may indicate where the alternate content is located. For example, this field 314 may indicate another channel, a web site URL or indicate that the content has been cached on the user's terminal device.

Optional message field 315 may include additional textual or graphical information regarding the hot key or the alternate content generated by the originating user. For example, the message field 315 may contain a text message from the originating user to the recipient user. This message may be presented to the user automatically or at his option to help the user decide whether to accept or decline the hot key.

FIG. 4 is a block diagram of a user side system to send and receive user originated content notification and redirect a user to alternate content responsive to selection of an embedded hot key according to one embodiment of the present invention. As discussed above, the user side system may vary significantly. The user side system comprising a terminal device, STB, Gateway or similar device, performs functions such as exchanging messages (including video-related data) over a network with head-end and data center, receiving messages from a user input device, such as a hand-held remote control unit, translating video signals from a network-native format into a format that can be used by televisions or other display devices, providing a video signal to televisions or other display devices, and other functions.

The functionality of the user side system may reside in a stand-alone device, literally a box that can be placed on, or at least near, the television, that is similar in outward form to conventional devices for receiving cable programs. The user side system functionality could alternatively be performed by hardware resident elsewhere, such as within the television or display console, or by any suitably equipped terminal device. Since the hardware may be proprietary to the service provider and may generally be a physically independent device, the term set top box is used here, but any type of terminal device with similar functionality may be used.

Typically, the broadcast from head-end and data center comprises a carrier frequency modulated with compressed video signals of multiple channels multiplexed together. The user side system receives, demodulates, demultiplexes, and decompresses this signal. In the example illustrated in FIG. 4, the user side system comprises an STB 205. STB 205 comprises tuner, receiver, demodulator 401, demultiplexor 402, decoder 403, graphics processor 404, central processing unit (CPU) 405, modulator and transmitter 406 or other mass storage device, memory 407, and various possible inputs and outputs 408.

Tuner, receiver, demodulator 401 receives signals from the service provider network 203 over any of a variety of media as discussed above. Specifically, tuner, receiver, demodulator 401 receives signals of a frequency band to which it is tuned and demodulates the signals to remove content signals from a carrier signal if any. Demodulated content signals are then supplied by tuner, receiver, and demodulator 401 to demultiplexor 402.

Demultiplexor 402 receives the demodulated content signals from tuner, receiver, demodulator 401 and separates the content into multiple data streams representing various channels. The multiple data streams are then supplied as an input to decoder 403.

Decoder 403 receives the multiple data streams from demultiplexor 402 and decodes or decompresses the data streams using an appropriate algorithm. For example, if the head-end and data center compressed the video signals into a Motion Pictures Experts Group Standard 2 (MPEG-2) data stream, decoder 403 will decode the MPEG-2 data stream from demultiplexor 402 to form a standard video signal. The video signal from decoder 403 is then supplied to graphics processor 404.

Graphics processor 404 receives the decoded video signals from decoder 403 and processes the video signals to reduce noise, provide amplifications, etc. Processed video signals from graphics processor 404 are supplied to input/output module 408. Input/output module 408 may provide a variety of possible output types. For example, outputs may include but are not limited to Audio/Video (A/V), Radio Frequency (RF), Sony/Phillips Digital Interface (SPDIF), Universal Serial Bus (USB), and others.

Input/output module 408 also receives control signals from the user. These control signals are typically InfraRed (IR) or Radio Frequency (RF) signals from a remote control unit. Control signals from the user are then fed back from input/output module 408 to Central Processing Unit (CPU) 405.

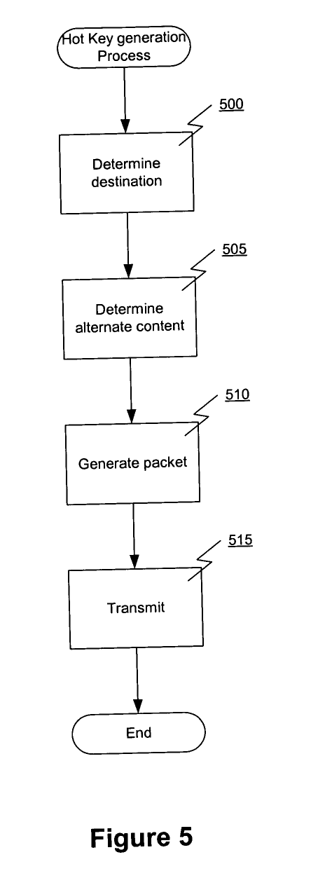

CPU 405 executes instructions stored in memory 407. Memory 407 may comprise a Random Access Memory (RAM) such as flash memory, or other non-volatile memory. The instructions stored in memory 407, when executed by CPU 405 cause CPU 405 to perform various functions such as controlling the various elements of STB 205, generating user originated hot key signals, receiving hot key signals, and switching to alternate content as will be described below with reference to FIGS. 5 and 6.

Generally, a hot key signal will be received at tuner, receiver, and demodulator 401 along with and embedded in content signals from the head-end and data center and transmitted over service provider network 203. CPU 405 monitors the demultiplexed data streams from demultiplexor 402 for the presence of relevant hot key signals.

A user originated hot key signal may be generated by CPU 405 and transmitted via service provider network 203 by modulator and transmitter 406. Generation of hot key signals may be triggered by control signals 410 from the user. A variety of methods may be used to trigger the generation of a hot key signal. For example, the remote control unit may have a button that may be pressed to start a hot key generation process. Alternatively, a combination of buttons or a cursor control may be pressed by the user to initiate the hot key generation process. The process for generating and sending user originated hot key signals will be discussed below with reference to FIG. 5.

Regardless of the exact operation used by the user to initiate the hot key generation process, CPU 405 will generate a specialized signal such as the IP packet described above with reference to FIG. 3. This signal will likely have a destination associated with it. Therefore, the user may be prompted by CPU 405 to enter a user name or other identifier for the intended destination. This data may be entered by the user via a keyboard, buttons on the remote control, some form of cursor control or pointing device, or another method. The alternate content designated by the hot key signal may automatically be set as the current content being viewed by the user generating the hot key signal. Alternatively, the user may be prompted to designate the alternate content via a keyboard, buttons on the remote control, some form of cursor control or pointing device, or another method. Once generated by CPU 405, the hot key signal will be modulated and transmitted over service provider network 203 by modulator and transmitter 406.

FIG. 5 is and flowchart illustrating processing on a user side system for generating and sending user originated content notification signals according to one embodiment of the present invention. First, at processing block 500, a destination is determined. The destination may be determined from a user name or other identifier for the intended destination entered by a user. The user may enter this information via a keyboard, buttons on the remote control, some form of cursor control or pointing device, or another method. Using one of a variety of possible input methods, the user may select a destination from a list or menu of choices or may type or otherwise enter destination information.

Next, at processing block 505, the alternate content that will be indicated by the hot key signal will be determined. According to one embodiment of the present invention, this determination may be made automatically and may be based on the user's currently viewed content. Alternatively, the user may be prompted to designate the alternate content via a keyboard, buttons on the remote control, some form of cursor control or pointing device, or another method. Using one of a variety of possible input methods, the user may select alternate content from a menu or program guide or may otherwise an indication of the alternate content.

Optionally, a determination of the content type may also be made and included in the hot key signal. Determining the content type for the available content may be automatically based on the content type being viewed by the user. Alternatively, the user may be prompted to designate the content type via a keyboard, buttons on the remote control, some form of cursor control or pointing device, or another method.

At processing block 510 the appropriate packet or other signal is generated. The signal will include the previously determined destination and indication of alternate content. Additionally, the signal may include an indication of the source such as a source IP address as well as other header information as discussed above with reference to FIG. 3.

Finally, at processing block 515, the generated signal is used to modulate an appropriate carrier frequency or is otherwise placed into an appropriate format and transmitted over the service provider's network.

FIG. 6 is a flowchart illustrating processing on a user side system for receiving and redirecting a user to alternate content responsive to selection of an embedded hot key according to one embodiment of the present invention. This process may be performed by a system such as described above with reference to FIG. 4 or any other system with similar capabilities.

First, at processing block 600, the system receives a hot key signal from the service provider's network. As discussed above, the hot key signal may be in the form of a specialized IP packet or another type of signal embedded in the content signal from the service provider.

At decision block 605 a determination is made as to whether the hot key signal is relevant to the particular user. Since numerous hot key signals may be present on the content provider's network at any particular time, the signals may be filtered before being presented to the user. Such filtering may be based on any number of possible algorithms and criteria. For example, only hot key signals related to a channel that is presently being viewed may be considered relevant. Another criteria for determining relevance of a hot key signal may be choices of content type or genres which have been selected by the user. Regardless of the algorithm or criteria used to judge relevance, if the hot key signal is determined at decision block 605 to not be relevant, no further processing is performed.

If the hot key signal is determined at decision block 605 to be relevant to the user, a hot key icon or other indication is displayed to the user at processing block 610. As mentioned above, this indication may be in the form of an icon placed on the screen, a text message, a tone or even a verbal alert. Regardless of the exact form, some indication is given to the user that a hot key has been received.

At decision block 615 a determination is made as to whether the user has accepted the hot key. As discussed above, the user may use any of a variety of means to indicate acceptance of the hot key. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Regardless of the exact means of accepting or declining the hot key, if it is determined at decision block 615 the user did not accept the hot key, no further processing is performed.

If, at decision block 615, the user accepts the hot key, the user is redirected to the alternate content at processing block 620.

At decision block 625 a determination is made as to whether the user has finished consuming the alternate content. This determination may be based on any of a variety of possible criteria. For example, the user may press a button or series of buttons on a remote control to indicate that he has finished viewing the presented material. Alternatively, the user may use a mouse or other pointing device of a remote control to select a graphic on the display to indicate that he has finished viewing the presented material.

Once a determination is made at decision block 625 that the user is finished with the alternate content, a return process is entered at processing block 630. This return process may include simply returning the user to the previous content. Alternatively, the return process may comprise presenting to the user other available content based on other hot key signals. Another alternative may include presenting a user with a number of choices of how to proceed.

What is claimed is:

1. A method of originating a hot key signal from a terminal device of a first user of an interactive television service, the method comprising:
determining a destination for the hot key signal;
determining a location of the available content;
generating the hot key signal, the hot key signal including the destination for the hot key signal and the location of the available content; and
transmitting the hot key signal from the terminal device of the first user over a network connected with the terminal device of the first user.

2. The method of claim 1, wherein the destination for the hot key signal is terminal device of a second user of the interactive television service.

3. The method of claim 1, wherein the location of the available content is an indication of a channel.

4. The method of claim 1, wherein the hot key signal comprises an Internet Protocol (IP) data packet, the IP data packet having a header portion and a body portion, the header portion having a data field indicating the destination of the hot key signal and the body portion having a data field indicating the location of the available content.

5. The method of claim 4, wherein the destination for the hot key signal is an IP address of a terminal device of a second user of the interactive television service.

6. The method of claim 1, wherein determining a location of the available content is based on a current content being viewed by the user.

7. The method of claim 1, wherein determining a location of the available content is based on an indication of a channel from the user.

8. The method of claim 6, wherein generating the hot key signal further comprises determining a content type for the available content.

9. The method of claim 8, wherein determining the content type for the available content is based on a type of the current content being viewed by the user.

10. A system comprising:
a processor;
a memory, the memory having stored therein a series of instructions for originating a hot key signal from a terminal device of a first user of an interactive television service, the series of instructions, when executed by a processor, cause the processor to determine a destination for the hot key signal, determine a location of the available content, generate the hot key signal, the hot key signal including the destination for the hot key signal and the location of the available content; and
a transmitter to transmit the hot key signal over a network connected with the transmitter.

11. The system of claim 10, wherein the destination for the hot key signal is a terminal device of a second user of the interactive television service.

12. The system of claim 10, wherein the location of the available content is an indication of a channel.

13. The system of claim 10, wherein the hot key signal comprises an Internet Protocol (IP) data packet, the IP data packet having a header portion and a body portion, the header portion having a data field indicating the destination of the hot key signal and the body portion having a data field indicating the location of the available content.

14. The system of claim 13, wherein the destination for the hot key signal is an IP address of a terminal device of a second user of the interactive television service.

15. The system of claim 10, wherein the processor determines a location of the available content based on a current content being viewed by the user.

16. The system of claim 10, wherein the processor determines a location of the available content based on an indication of a channel from the user.

17. The system of claim 15, wherein generating the hot key signal further comprises determining a content type for the available content.

18. The system of claim 17, wherein determining the content type for the available content is based on a type of the current content being viewed by the user.

19. A machine-readable medium having stored thereon a series of instructions for originating a hot key signal from a terminal device of a first user of an interactive television service, the series of instructions, when executed by a processor, cause the processor to:
determine a destination for the hot key signal;
determine a location of the available content;
generate the hot key signal, the hot key signal including the destination for the hot key signal and the location of the available content; and
transmit the hot key signal from the terminal device of the first user over a network connected with the terminal device of the first user.

20. The machine-readable medium of claim 19, wherein the destination for the hot key signal is a terminal device of a second user of the interactive television service.

21. The machine-readable medium of claim 19, wherein the location of the available content is an indication of a channel.

22. The machine-readable medium of claim 19, wherein the hot key signal comprises an Internet Protocol (IP) data packet, the IP data packet having a header portion and a body portion, the header portion having a data field indicating the destination of the hot key signal and the body portion having a data field indicating the location of the available content.

23. The machine-readable medium of claim 22, wherein the destination for the hot key signal is an IP address of a terminal device of a second user of the interactive television service.

24. The machine-readable medium of claim 19, wherein determining a location of the available content is based on a current content being viewed by the user.

25. The machine-readable medium of claim 19, wherein determining a location of the available content is based on an indication of a channel from the user.

26. The machine-readable medium of claim 24, wherein generating the hot key signal further comprises determining a content type for the available content.

27. The machine-readable medium of claim 26, wherein determining the content type for the available content is based on a type of the current content being viewed by the user.
